(19) United States
(12) Patent Application Publication
(10) Pub. No.: US 2022/0220932 A1
(43) Pub. Date: Jul. 14, 2022

(54) ELECTRICAL ENERGY GENERATION DEVICE

(71) Applicant: Sidnei Schmidt, Lajerado (BR)

(72) Inventor: Sidnei Schmidt, Lajerado (BR)

(21) Appl. No.: 17/611,837

(22) PCT Filed: Aug. 23, 2019
(86) PCT No.: PCT/BR2019/050349

§ 371 Date: Nov. 16, 2021

(30) Foreign Application Priority Data
May 16, 2019 (BR) BR 10 20190100559

(51) Int. Cl. F03B 17/06; H02K 7/18; H02K 21/24; E04D 13/08

(52) U.S. Cl. CPC F03B 17/063; H02K 7/18; H02K 21/24; E04D 13/08; F05B 2260/42; F05B 2220/7068; F05B 2220/7066; F05B 2250/712; F05B 2220/20

(57) ABSTRACT

This invention describes the electrical power generation in a sustainable way, by means of a device, which is installed in the downpipes of rainwater collected by the building roofs, capable of transforming the potential energy present in said rainwater runoff into electrical power, where the generated energy is stored in batteries or fed into the utility network.

### FIELD OF THE INVENTION

This invention applies in the field of devices that are developed for generating electric power efficiently and a sustainable way.

This invention describes a device that is installed in the downpipes for rainwater collected from the roofs of buildings and changes the potential power present in the rainwater falls into electrical power.

### BACKGROUND OF THE INVENTION

In a globalized world where the energy demand is increasing, to depend only on power generators that need some fossil fuel type for their operation has become more and more obsolete, since such natural resources are becoming increasingly scarce, the society has been searching for more conscious and sustainable alternatives.

Thus, aiming to solve the issue highlighted above, the investment in non-conventional energies, such as solar, wind and hydraulic energy, has become increasingly common, and thus this invention proposes a device that changes the rainfall potential present on the roofs of buildings, whether they are new or existing, into electric power.

The Brazilian paper BR 102016007962-4 describes a device that is arranged in the water inlet pipe of a residential reservoir and is capable of changing the water flow into electrical power, storing that power in batteries that can be converted to alternating current for home use.

This paper show that for the device to work properly, the water should be at constant pressure and volume, thus moving away from this invention, which can work with low or high volumes.

Furthermore, while in this invention there is no restriction to the water passage, in the mentioned paper shows that it is necessary to install a conical injector nozzle that increases the pressure already existing in the hydraulic system, to concentrate it on the turbine blades.

The hydraulic network this paper refers to, is the consumption network or the supply network working with water reservoirs and is pressurized, working in a “flooded” way

In this invention, the rain drop pipelines cannot work in the “flooded” mode, i.e. with the pipe full of water, so any kind of bottleneck should be prevented at any point of the pipe, because if any injector nozzle is installed in the rainwater network, the pipes will be impaired, besides reducing greatly the flow, causing overflows and clogging by dirt (leaves, twigs, etc. . . . ) that may be on the roofs and in the gutters.

The paper BR 102015017554-0 outlines a generator that is capable of changing hydraulic power present in rainwater falls from buildings, into electrical power using the following components: generator, rectifier circuit, voltage regulator circuit, capacitor bank, battery bank, and voltage inverter.

This paper shows that, for the device to work properly, it is necessary for the water to be at constant pressure and volume, thus moving away itself from this invention, which can work at low or high volumes.

Furthermore, while in the present invention there is no restriction to the passage of water, in this paper there is a need to install a kind of conical injector nozzle to pressurize the system and thus allow the passage of water in rainfalls.

The paper BR 102014020063-0 proposes a power generation system that employs as its generating source, the piped water supply network, i.e., it uses the pressurized water flow supplied by piped water supply networks.

This paper differs from this invention in that it uses the excess pressure present in the hydraulic network at the reservoir intake, while this invention uses the potential power present in the rainwater fall of buildings.

The Brazilian paper PI 1002676-2 describes a system for harnessing rainwater in buildings by using the gravitational potential energy of water, aiming to generate sustainable power that will be used by the building itself.

In order for the system presented herein to be able to store and transfer the building water, it is necessary that it uses pipes, check valves, siphons, and so on.

Thus, the aforementioned paper differs from this invention, since the latter fosters the generation of electrical power through waterfalls with the use of a device that is directly connected to the rainfall pipes and uses as few mechanical parts as possible.

Therefore, it can be concluded that this invention differs from the state of the art papers presented herein, since none of them refers to a device capable of changing the potential energy present in the waterfalls of buildings into electrical power, without the need for constant water pressure and volume.

### SUMMARY OF THE INVENTION

This invention describes the electric power generation in a sustainable way, by means of a device installed in downpipes of the rainwater captured from the building's roofs, capable of transforming the potential energy present in said rainwater runoff into electric power, where the generated energy is stored in batteries or fed into the utility network.

### BRIEF DESCRIPTION OF THE FIGURES

This invention can be better understood by a brief description the following figures:

FIG. 1 represents an exploded view of the electric energy generating device;

FIG. 2 represents a perspective view of the device for generating electric energy.

FIG. 3 represents the electric power generating device installed in a rainwater pipeline.

FIG. 4 represents a block diagram of the storage and distribution of the energy generated by the electric power generation device.

### DETAILED DESCRIPTION OF THE INVENTION

This invention describes the electric power generation in a sustainable way, by means of a device which is installed in the downpipes of the rainwater collected by the building roofs, capable of changing the potential energy present in said rainwater runoff into electric power, where the generated energy is stored in batteries or fed into the utility network.

This device can be installed in both new and existing buildings, since it is very easy to install, and more than one of them can be installed in the same water column.

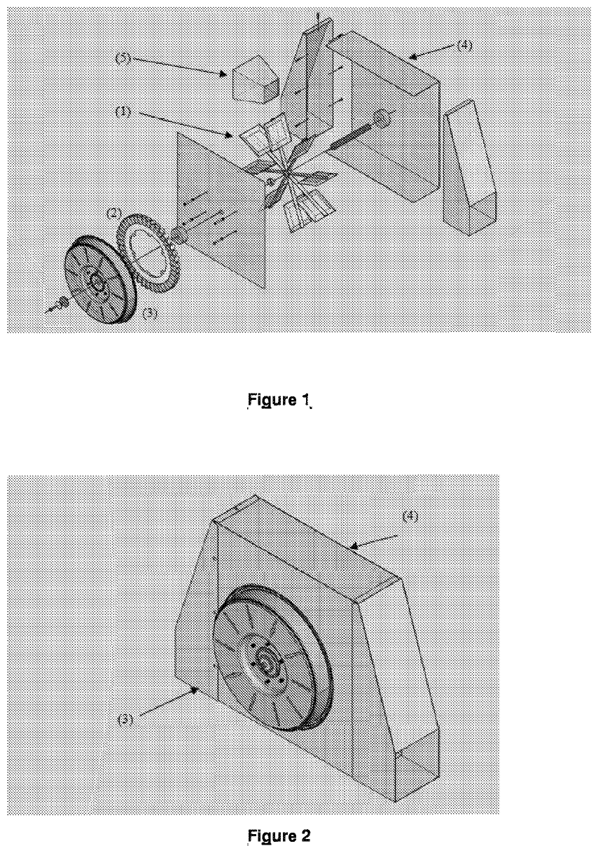

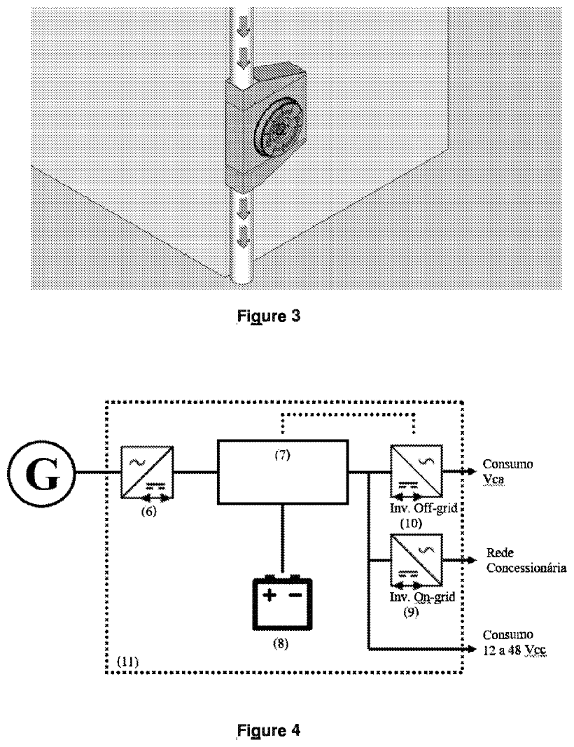

As shown in FIG. 1, this device consists of the following components:
concave-bladed turbine (1)—An element capable of transforming the potential energy of the waterfall into rotation;
permanent magnet generator stator (2)—Fixed generator component, where the windings and wiring are located;
permanent magnets generator rotor (3)—Movable component of the generator, which has the permanent magnets positioned in an alternative manner to generate the induction on the stator (2), according to the movement;
protective casing (4)—An element destined to the turbine's casing to prevent any external contact or the water from scattering away;
water flow concentrator (5)—Conical component for directing the water flow to a given point.

Through the waterfall, the device drives a concave blades turbine (1), thus generating enough voltage to drive the permanent magnet generator rotor (3), regardless of whether the water volume or flow is being held constant, since both the frequency and the generated voltage are handled electronically.

Thus, the device herein pleaded does not present a restriction on the water passage, since the generator blades are driven by the water flow passing through the flow concentrator (5) and directs the volume to the turbine blades (1).

The referred flow concentrator (5), which presents an angle from 10° to 20°, has the sole function of directing the water flow, causing a minimal restriction in the water course or any impurity (dirt, branches, leaves, etc.) that might be in the system.

After passing through the flow concentrator (5), the water reaches the turbine blades (1), generating the rotor movement, and thus, it flows freely through the interior of the turbine and returns to its normal course through the piping.

That is, in this invention, the concave blades turbine (1) is able to capture volumes of water ranging from small to large, taking into account that the rainfall is not constant.

Such a turbine with concave blades (1) can be changed according to the installation site, by varying the number of blades and the distance of the blades from the shaft, thus enabling the installation in sites with different water volumes and different water columns.

The permanent magnet generator rotor (3) is coupled directly to the turbine shaft with concave blades (1), thus enabling the power generation with as little mechanical loss as possible, and at low rotation speeds.

Low mechanical losses occur due to direct coupling of the rotor shaft of the permanent magnet generator (3) to the concave blades turbine shaft (1), without any type of belt, pulleys, or adaptation that could generate mechanical losses.

Such direct coupling is possible because this invention uses a permanent magnet generator, consisting of the permanent magnet generator stator (2) and permanent magnet generator rotor (3), which shows a range of 6 to 12 poles, where such a variation of the number of poles occurs in said stator of the permanent magnet generator (2) and in said rotor of the permanent magnet generator (3) by changing the number of permanent magnets, and thus making the voltage generation at low rotation possible.

If any other type of generator was used, the turbine shaft speed would have to be mechanically increased, and through pulleys or gearboxes, which would result in many Additionally, in order for the power generated by the device to be stored, controlled and distributed, external elements—such as: full-wave rectifier (6), charge controller (7), batteries (8), on-grid inverter (9) and off-grid inverter (10)—are internally allocated to a metal box (11), which is located next to the said device and is interconnected to the device be means of conventional electrical wiring, as shown in FIG. 4.

In cases where larger battery banks are required, the batteries can be installed separately from the other components, also interconnected by conventional electrical cables with gauge, according to the project current. All power generated by the device goes through a full wave rectifier (6), which delivers a continuous but variable voltage to the load controller (7).

As the delivered voltage rises, the charging of the batteries (8) increases, generating more weight on the permanent magnet generator rotor (3), which will automatically stabilize the voltage according to the amount of water being supplied for generation.

After the batteries (8), a consumption system is installed, which may be either equipment in the range of 12V and 48V and is directly connected to the battery, (8) or on-grid inverters (9) or off-grid inverters (10), according to the site's needs.

The batteries (8) can be connected in series, parallel, or both, thus making it possible to form the voltage and current set according to the system's needs and size.

Such batteries (8) should be of the rechargeable lead acid, lithium, or any other type that allows charging and discharging, as required by the system.

The charge controller (7) is accountable for accumulating the energy generated electronically and with batteries (8) by measuring the voltages and currents in the batteries (8).

In case the batteries (8) are at a low load level, that load controller (7) disconnects the inverters and battery consumers, thus increasing their lifespan.

On the other hand, if there is excess power generation and the batteries (8) are fully charged, the charge controller (7) directs the generated energy to the on-grid inverter (9) which feeds that energy into the utility network, thus preventing any generated energy from being wasted.

This invention has been disclosed in this descriptive report in terms of its preferred mode. However, other changes and variations are possible from this description and are still within the scope of the invention disclosed herein.

1-11. (canceled)

12. An electric power generation device comprising:
a concave blades turbine (1) and a water flow concentrator (5) enclosed inside a protective housing (4); and
a permanent magnet generator having a stator (2) and a rotor (3), said permanent magnet generator being electrically connected to electrical components enclosed inside an external a metal box (11) for storing, controlling and distributing electric energy generated by said permanent magnet generator.

13. The electric power generation device according to claim 12, wherein the concave blades turbine (1) is driven by water flowing through said water flow concentrator (5).

14. The electric power generation device according to claim 12, wherein the rotor (3) of said permanent magnet generator is driven by a voltage generated by the concave blades turbine (1).

15. The electric power generation device according to claim 12, wherein the rotor (3) of said permanent magnet generator is directly coupled to a shaft of the concave blades turbine (1).

16. The electric power generation device according to claim 12, wherein the stator (2) and the rotor (3) have a 6 to 12 poles range.

17. The electric power generation device according to claim 12, wherein said electrical components comprise a full-wave rectifier (6), a charge controller (7), batteries (8), an on-grid inverter (9), and an off-grid inverter (10).

18. The electric power generation device according to claim 17, wherein the full wave rectifier (6) receives the electric energy provided by said permanent magnet generator and delivers a continuous and variable voltage to the charge controller (7).

19. The electric power generation device according to claim 17, wherein the charge controller (7) stores the generated electric energy electronically on said batteries (8).

20. The electric power generation device according to claim 19, wherein the rotor (3) of said permanent magnet generator becomes heavier as a charge of said batteries (8) increases, stabilizing a voltage generated based on an amount of water being supplied for generation.

21. The electric power generation device according to claim 17, wherein a consumption system is installed after the batteries (8), said consumption system comprising equipment at a voltage of at least one of 12V or 48V connected directly to at least one of the batteries (8), the on-grid inverter (9) or the off-grid inverter (10).

22. The electric power generation device according to claim 12, wherein the electric energy is generated through water flowing through a rainwater downpipe.
